(19) United States
(12) Patent Application Publication
(10) Pub. No.: US 2010/0165918 A1
(43) Pub. Date: Jul. 1, 2010

(54) MOBILE COMMUNICATION SYSTEM, RADIO NETWORK CONTROLLER, CELLULAR AND LOCATING CELL DISPLAY METHOD FOR USE THEREWITH

(76) Inventor: Tsukasa Kobayashi, Tokyo (JP)

Correspondence Address: Mr. Jackson Chen, 6535 N. STATE HWY 161, IRVING, TX, 75039, US

(21) Appl. No.: 12/438,221

(22) PCT Filed: Aug. 22, 2007
(86) PCT No.: PCT/JP2007/066239

§ 371 Date: Feb. 20, 2009

(30) Foreign Application Priority Data
Aug. 23, 2006 (JP) 2006-225966

(51) Int. Cl. H04W 40/00; H04W 88/06

(52) U.S. Cl. 370/328; 455/552.1

(57) ABSTRACT

The present invention provides a mobile communication system in which a cellular is capable of notifying the user of correct information of an event that the cellular is locating in a cell supporting HSDPA and an event that the cellular is locating in a cell supporting E-DCH. There are notified reconfiguration messages each of which includes “HSDPA cell indicator” and “E-DCH cell indicator” from a cellular base station apparatus 2 to a cellular 1. When the cellular 1 moves from cell A to cell B while communicating via a dedicated channel, the cellular 1 determines “HSDPA cell indicator” and “E-DCH cell indicator” in a “physical channel reconfiguration” message and conducts pictograph display on the screen to indicate whether or not the locating cell is a cell supporting HSDPA or E-DCH (HSUPA).

### TECHNICAL FIELD

The present invention relates to a mobile communication system, a radio network controller, a cellular, and a locating cell display method for use therewith, and in particular, to locating cell display for a cell supporting High Speed Downlink Packet Access (HSDPA) and a cell supporting Enhanced-Detected Channel (E-DCH).

### RELATED ART

In a mobile communication system of, for example, Wideband-Code Division Multiple Access (W-CDMA), there is notified, to a user of a cellular, as an indicator to determine whether or not the user is currently locating in a cell supporting HSDPA and E-DCH (High Speed Uplink Packet Access (HSUPA)), an HSDPA Cell Indicator or an E-DCH Cell Indicator using notification information (System Information Block Type 5 or System Information Block Type 5bis; reference is to be made to, for example, Non-Patent Document 1).

The cellular determines whether or not the indicator is True (true) to display pictograph on a screen indicating that the user is locating in a cell supporting HSDPA or a cell supporting E-DCH. Although depending on an application installed in the cellular, if the user is locating in a cell supporting HSDPA/E-DCH, it is possible to issue a packet call setup request in a format with a designation of Quality of Service (QoS) by setting a bit rate of a packet supporting HSDPA/E-DCH.

In other words, if the user is locating in a cell which is not supporting HSDPA/E-DCH, it is possible to issue a packet call setup request in a format with a designation of QoS by setting a bit rate corresponding to Release 99 of 3rd Generation Partnership Project (3GPP). Non-Patent Document 1; “Radio Resource Control (RRC); Protocol Specification (Release 7) 10.2.48.8.8 System Information Block Type 5 and 5bis” [3GPP TS 25.331 v7.11.0 (2006-06)]

### DISCLOSURE OF THE INVENTION

### Problem to be Solved by the Invention

However, in the conventional mobile communication system as described above, the notification information cannot be acquired when a dedicated channel (Detected Channel (DCH)) is assigned to the cellular; hence, when the cellular moves into another cell through processing such as a handover, there does not exists an identifier to identify whether the cellular in the destination is locating in a cell supporting HSDPA or in a cell supporting E-DCH.

Therefore, an exemplary object of the present invention is to solve the above problem and to provide a mobile communication system, a radio network controller, a cellular, and a locating cell display method for use therewith capable of notifying a user of correct information indicating that the user is locating in a cell supporting HSDPA or E-DCH not only in a situation wherein the cellular is in a waiting state or is using a shared channel in which the cellular is capable of receiving the notification information, but also in a situation wherein the cellular moves to another cell while using a dedicated channel.

### Means for Solving the Problem

The mobile communication system in accordance with the present invention is a mobile communication system in which a base station apparatus notifies, by use of notification information from the base station apparatus to a cellular, service corresponding information of a cell under control of the base station apparatus to the cellular; in the system,

at a transition of a state of the cellular, the service corresponding information of the cell is added to a message to be notified from the base station apparatus and is notified to the cellular.

The radio network controller in accordance with the present invention is a radio network controller for controlling a base station apparatus in a system in which the base station apparatus notifies, by use of notification information from the base station apparatus to a cellular, service corresponding information of a cell under control of the base station apparatus to the cellular, the controller including:

means for determining, at a transition of a state of the cellular, a correspondence between a base station apparatus associated with the transition and the service of the cell; and means for adding, when it is determined that the base station apparatus corresponds to the service of the cell, the service corresponding information of the cell of the base station apparatus to a message to be notified from the base station apparatus to the cellular to thereby notify the information to the cellular.

The cellular in accordance with the present invention is a cellular to which, by use of notification information from a base station apparatus to a cellular, service corresponding information of a cell under control of the base station apparatus is notified, the cellular including:

means for determining a service correspondence of the cell according to the service corresponding information added to a message notified from the base station apparatus at a transition of a state of the cellular; and means for displaying on a screen the service correspondence of the cell obtained by determining the service correspondence.

The locating cell display method in accordance with the present invention is a locating cell display method for use with a mobile communication system in which a base station apparatus notifies, by use of notification information from the base station apparatus to a cellular, service corresponding information of a cell under control of the base station apparatus to the cellular; in the method,

at a transition of a state of the cellular, the service corresponding information of the cell is added to a message to be notified from the base station apparatus and is notified to the cellular.

That is, in the mobile communication system of the present invention, a reconfiguration message indicating a handover or the like is notified to the cellular by adding information of an High Speed Downlink Packet Access (HSDPA) cell indicator and information of Enhanced-Detected Channel (E-DCH) cell indicator.

The cellular displays, based on the HSDPA cell indicator or the E-DCH cell indicator notified from the network, on the screen whether the cellular is locating in a cell supporting HSDPA or a cell supporting E-DCH (High Speed Uplink Packet Access (HSUPA)).

More specifically, in the mobile communication system of the present invention, at reception of the reconfiguration message, the cellular includes a function to recognize the HSDPA cell indicator and the E-DCH cell indicator stored in the message.

Also, the cellular includes a function to confirm the HSDPA or E-DCH cell indicator notified from the network and to display on the screen, if the indicator is “True (true), pictograph (drawings using pictorial symbols or pictures) corresponding to “locating in cell supporting HSDPA” or “locating in cell supporting E-DCH”.

In the mobile communication system of the present invention, the base station apparatus includes a function to store the HSDPA and E-DCH cell indicators not only in the system information block type 5 (or the system information block type 5bis) but also in the reconfiguration message to send the message to the cellular.

Additionally, the mobile communication system of the present invention is applicable not only for services of HSDPA and E-DCH (HSUPA) but also for an operation in which the network notifies the cellular (user) of various service corresponding information of respective cells.

As a result, in the mobile communication system of the present invention, the correct information of “locating in a cell supporting HSDPA” or “locating in a cell supporting E-DCH” can be notified to the user not only when the cellular is in a waiting state or is using a shared channel in which the cellular is capable of receiving the notification information, but also when the cellular moves to another cell while using a dedicated channel.

### Advantages of the Invention

In accordance with the present invention, by using the configuration and the operation described above, there is obtained an advantage in which the correct information of “locating in a cell supporting HSDPA” or “locating in a cell supporting E-DCH” can be notified to the user not only when the cellular is in a waiting state or is using a shared channel in which the cellular is capable of receiving the notification information, but also when the cellular moves to another cell while using a dedicated channel.

### BEST MODE FOR CARRYING OUT THE INVENTION

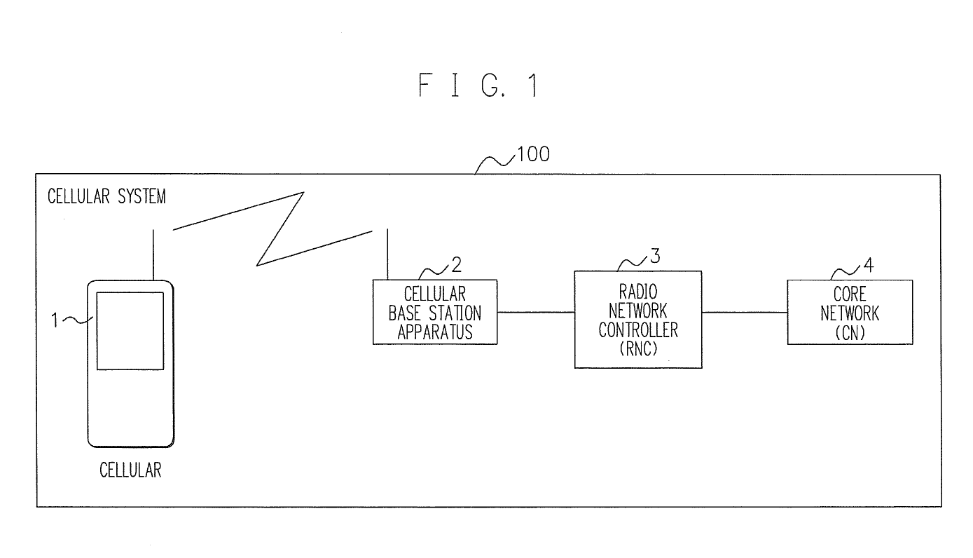

Next, description will be given of an exemplary embodiment of the present invention by referring to drawings. FIG. 1 is a block diagram showing a configuration example of a mobile communication system according to an exemplary embodiment of the present invention. In FIG. 1, a cellular system is shown as a mobile communication system, namely, a system configuration example of International Mobile Telecommunications-200 (IMT-200) Wideband-Code Division Multiple Access (W-CDMA).

In FIG. 1, the cellular system 100 includes a cellular 1, a cellular base station apparatus 2, a Radio Network Controller (RNC) 3, and a Core Network (CN) 4.

In the cellular system 100, the cellular 1 of a user, the cellular base station apparatus 2, and the radio network controller 3 to generally control the cellular base station apparatus 2 are connected to each other. Also, the radio network controller 3 is connected to the core network 4 for controlling position registration and call and managing user information. A range which the cellular base station apparatus 2 can cover is referred as a cell.

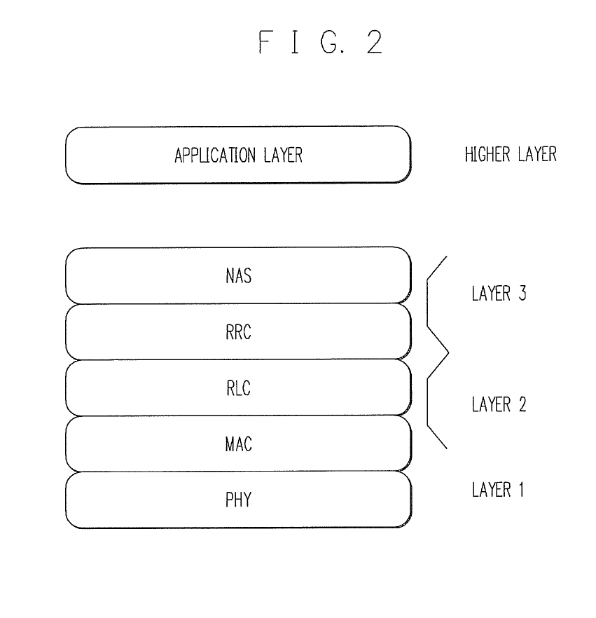

FIG. 2 is a diagram showing a protocol architecture of the radio interface employed in the exemplary embodiment of the present invention. FIG. 2 shows a protocol architecture of the radio interface assumed in a system of W-CDMA.

A Radio Resource Control (RRC) to control radio resources is connected to a Radio Link Layer (RLC) for providing a data transmission service to a higher layer, a Medium Access Controller (MAC) for conducting logical channel transmission and allocating a radio resource to RLC, and a PHYsical layer (PHY) for measuring radio transmission, radio quality, and the like via a transport channel.

Since the notification information is a message for RRC (layer 3) control, if “System information block type 5” (or “system information block type 5bis”) includes an HSDPA cell indicator or an E-DCH cell indicator indicating that the cellular is locating in a cell supporting HSDPA or E-DCH, the information is transferred from the RRC to an application layer to be notified to the user of the cellular 1 in the form of pictograph display on the screen.

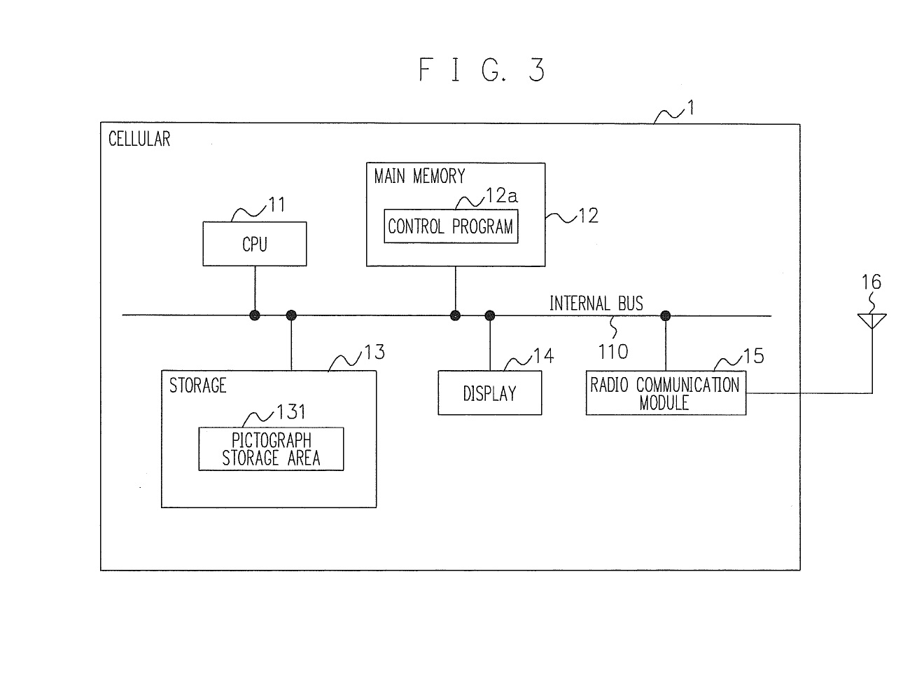

FIG. 3 is a block diagram showing a configuration example of the cellular 1 of FIG. 1. In FIG. 3, the cellular 1 includes a Central Processing Unit (CPU) 11, a main memory 12 for storing a control program 12a which the CPU 11 is to execute, a storage 13 which the CPU 11 uses as a work area or the like to execute the control program 12a, a display 14, a radio communication module 15, and an antenna 16.

The storage 13 includes a pictograph storage area 131 which stores data of pictograph (drawings using pictorial symbols or pictures) for indicating remaining battery power, a wave receiving state, an event in which the user is locating in a cell supporting HSDPA, an event in which the user is locating in a cell supporting E-DCH, and the like. Incidentally, in the cellular 1, the CPU 11, the main memory 12, the storage 13, the display 14, and the radio communication module 15 are respectively connected to an internal bus 110. Furthermore, FIG. 3 shows only elements of the cellular 1 associated with the present invention, and other elements such as an audio input/output module are not shown.

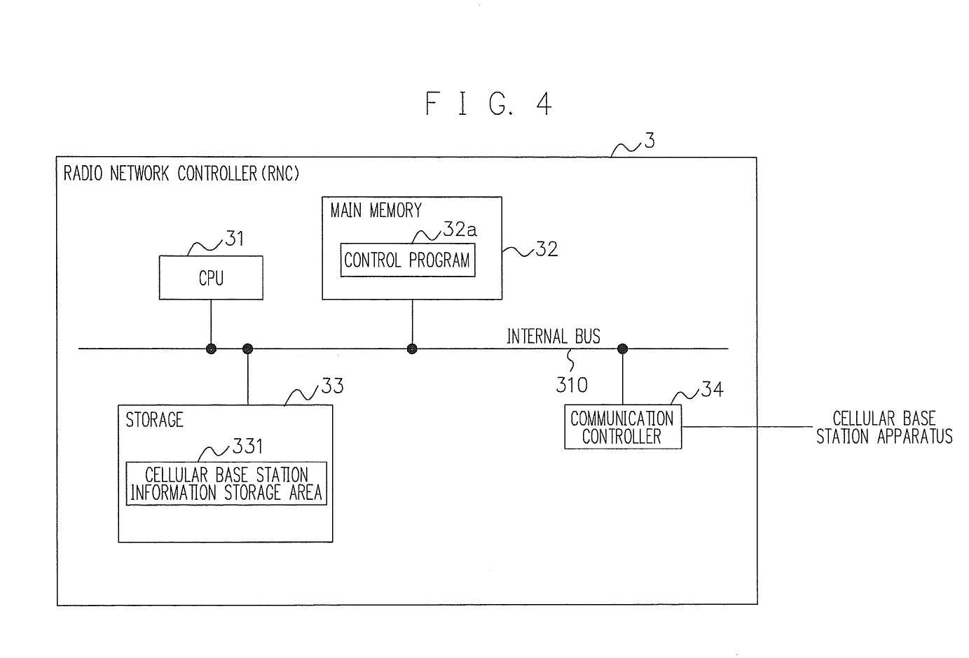

FIG. 4 is a block diagram showing a structure example of the radio network controller 3 of FIG. 1. In FIG. 4, the radio network controller 3 includes a CPU 31, a main memory 32 for storing a control program 32a which the CPU 31 is to execute, a storage 33 which the CPU 31 uses as a work area or the like to execute the control program 32a, and a communication controller 34.

The storage 33 includes a cellular base station information storage area 331 which stores at least cellular base station information indicating whether the cellular base station apparatus 2 corresponds to HSDPA or E-DCH. Incidentally, in the radio network controller 3, the CPU 31, the main memory 32, the storage 33, and the communication controller 34 are respectively connected to an internal bus 310. Moreover, FIG. 4 shows only elements of the radio network controller 3 associated with the present invention, and other elements for such as position registration processing of the cellular 1, processing for results of measurement of radio environments of the cellular 1, and the like are not shown.

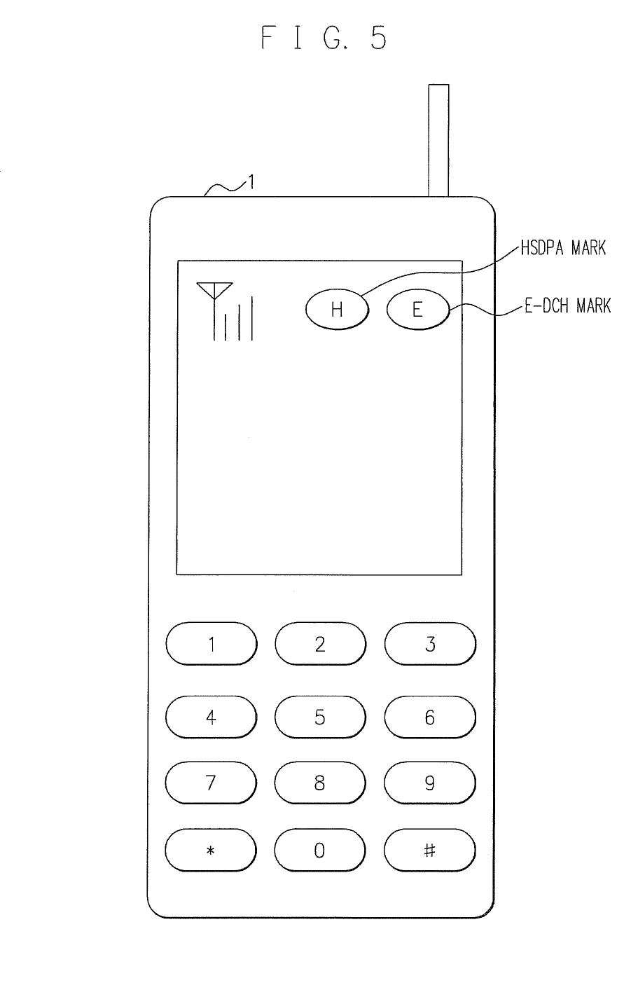

FIG. 5 is a diagram showing a pictograph example for the cellular 1 of FIG. 1, the example including an event in which the cellular is locating in a cell supporting HSDPA and an event in which the cellular is locating in a cell supporting E-DCH. In FIG. 5, the event in which the cellular is locating in a cell supporting HSDPA is represented using a combination of “H” and an ellipse and the event in which the cellular is locating in a cell supporting E-DCH is represented using a combination of “E” and an ellipse.

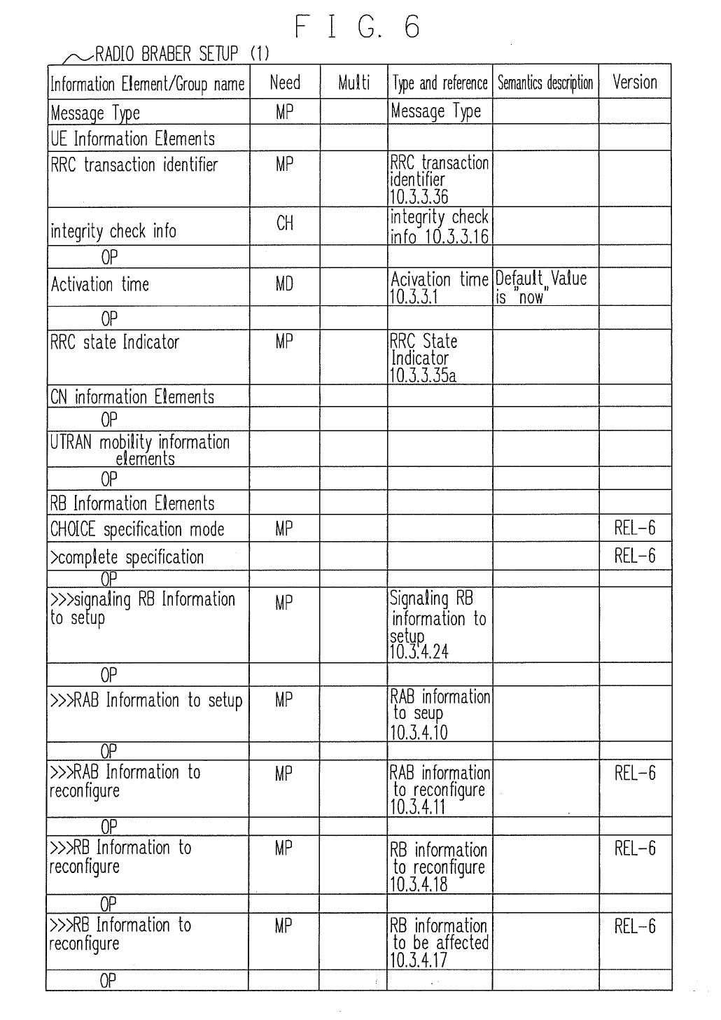

FIGS. 6 to 20 are diagrams showing format examples of the reconfiguration message in the exemplary embodiment of the present invention. In FIGS. 6 to 20, according to the exemplary embodiment, an HSDPA cell indicator is incorporated in the reconfiguration message, as information of an event in which the cellular is locating in a cell supporting HSDPA and an E-DCH cell indicator is incorporated in the reconfiguration message, as information of an event in which the cellular is locating in a cell supporting E-DCH.

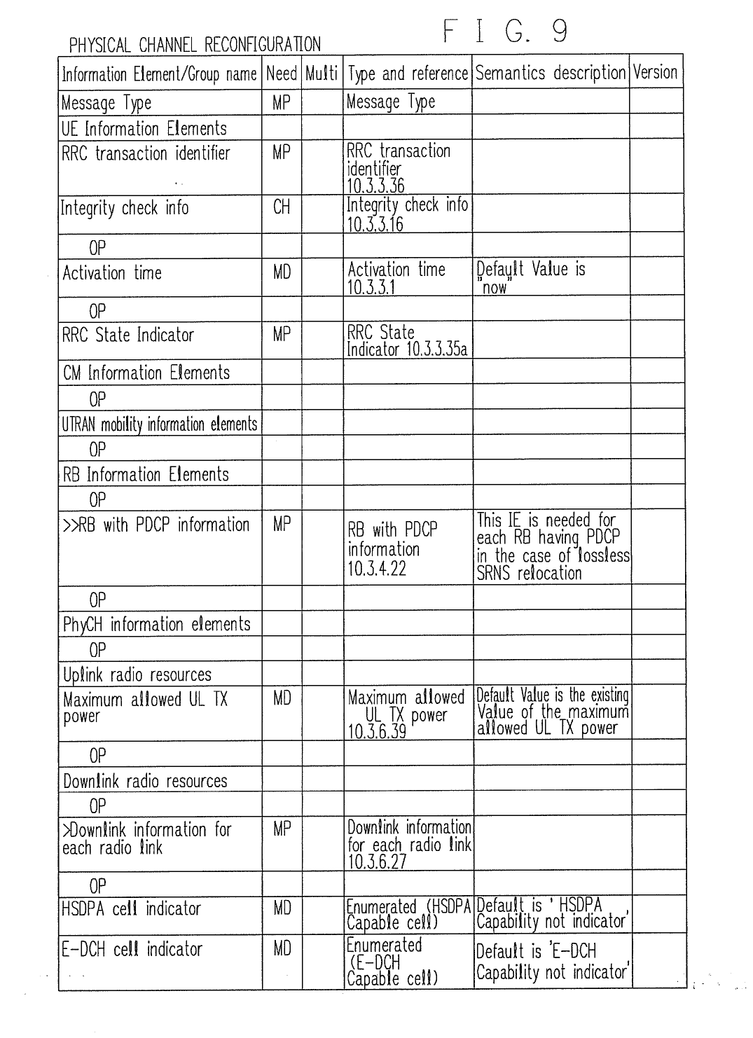

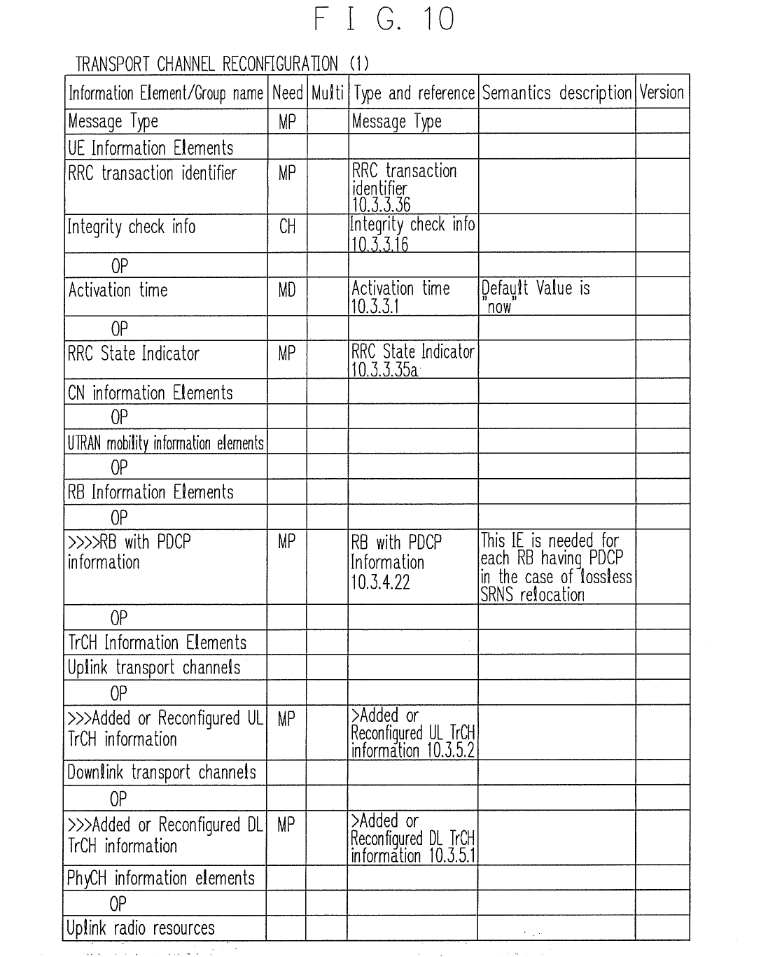

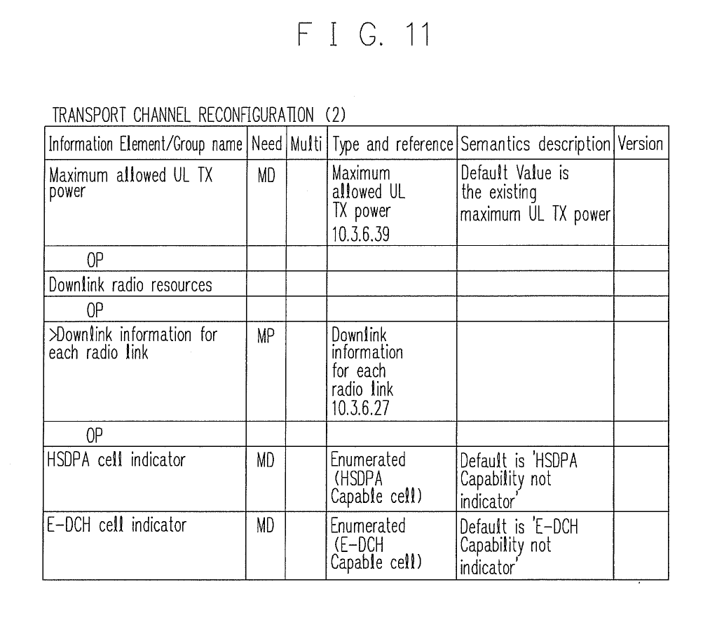

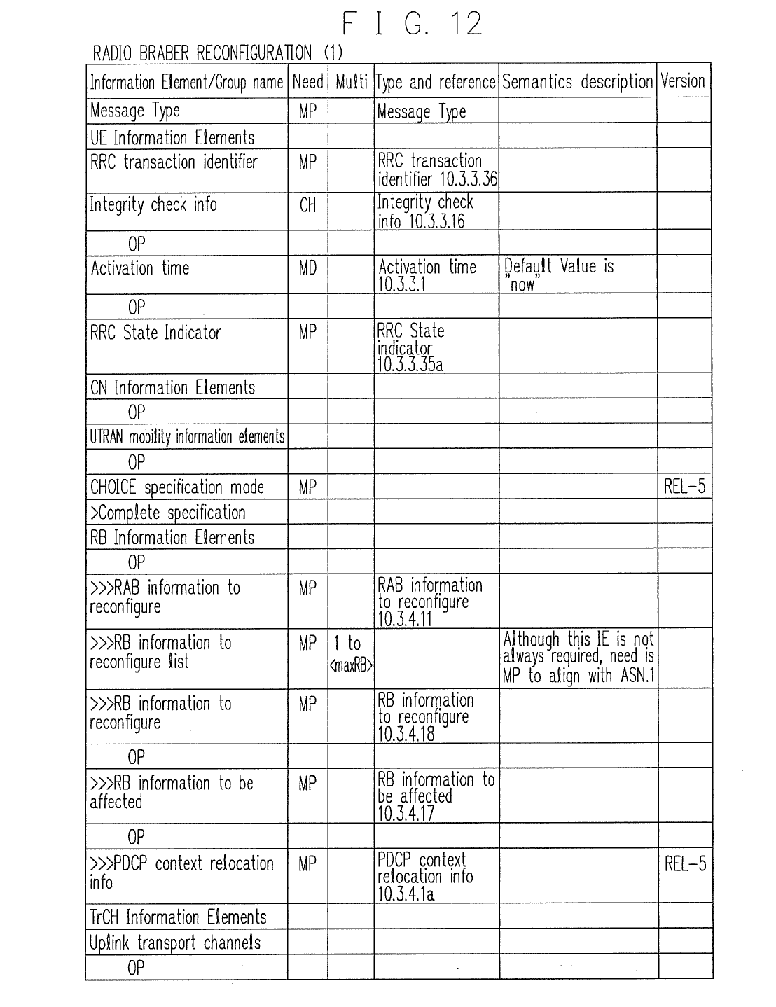

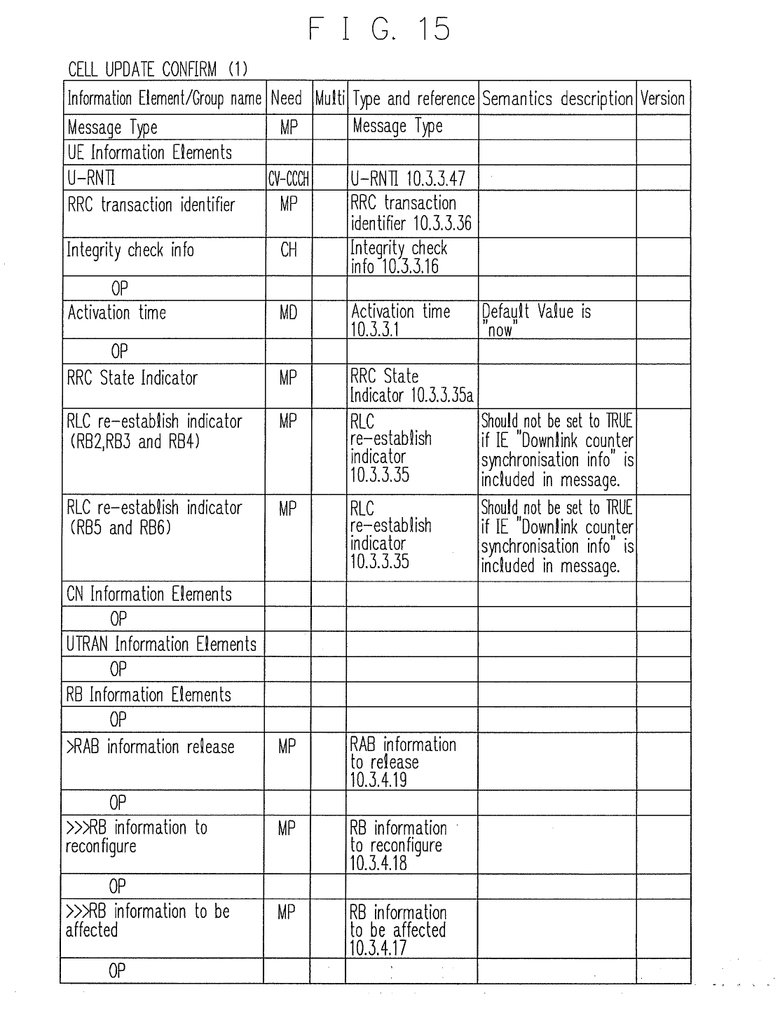

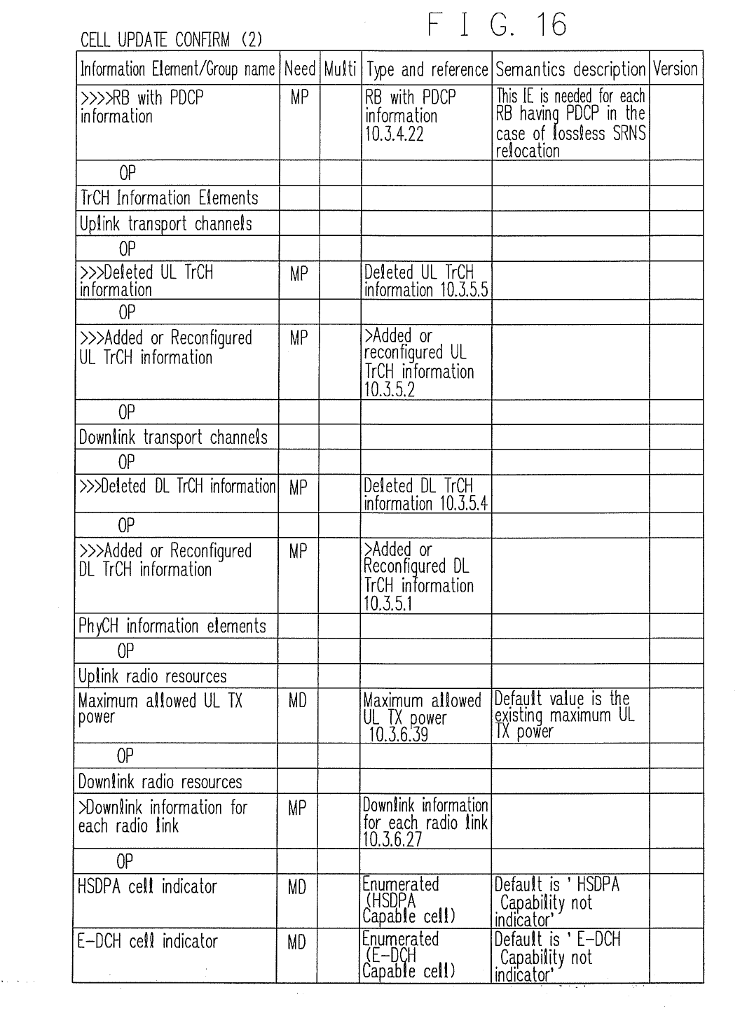

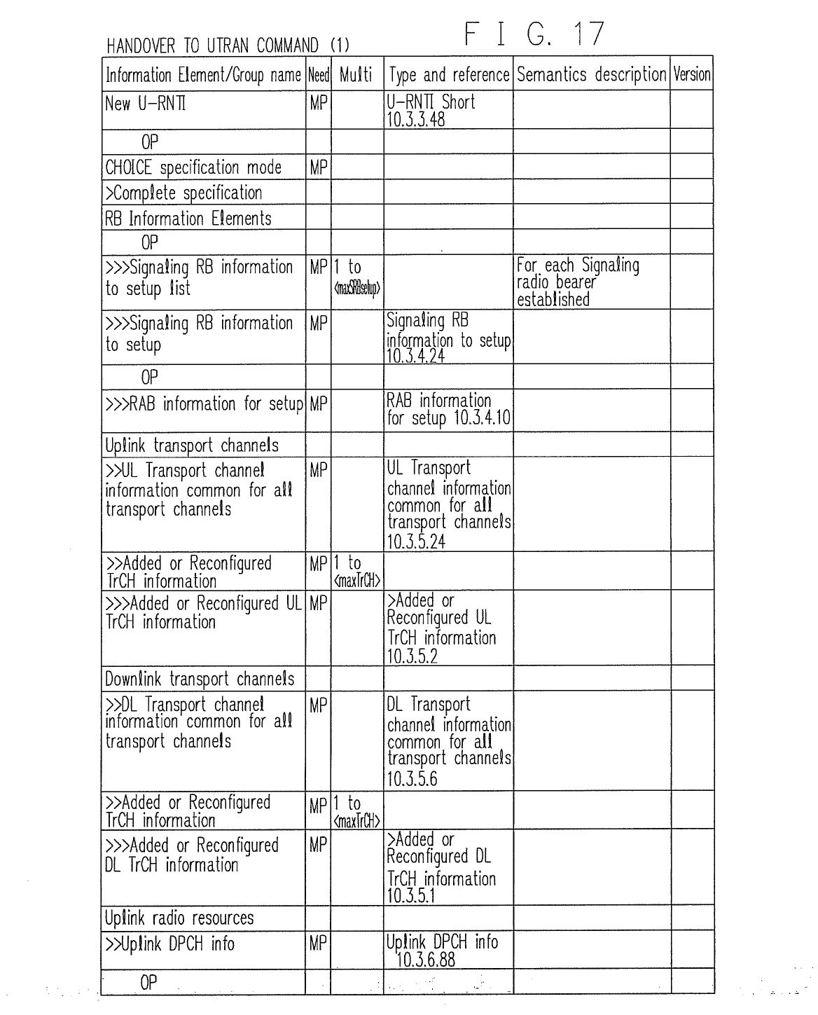

FIGS. 6 to 8 show format examples of “radio bearer setup”, FIG. 9 shows a format example of “physical channel reconfiguration”, FIGS. 10 and 11 show format examples of “transport channel reconfiguration”, FIGS. 12 to 14 show format examples of “radio bearer reconfiguration”, FIGS. 15 and 16 show format examples of “cell update confirm”, and FIGS. 17 to 19 show format examples of “handover to utran command”.

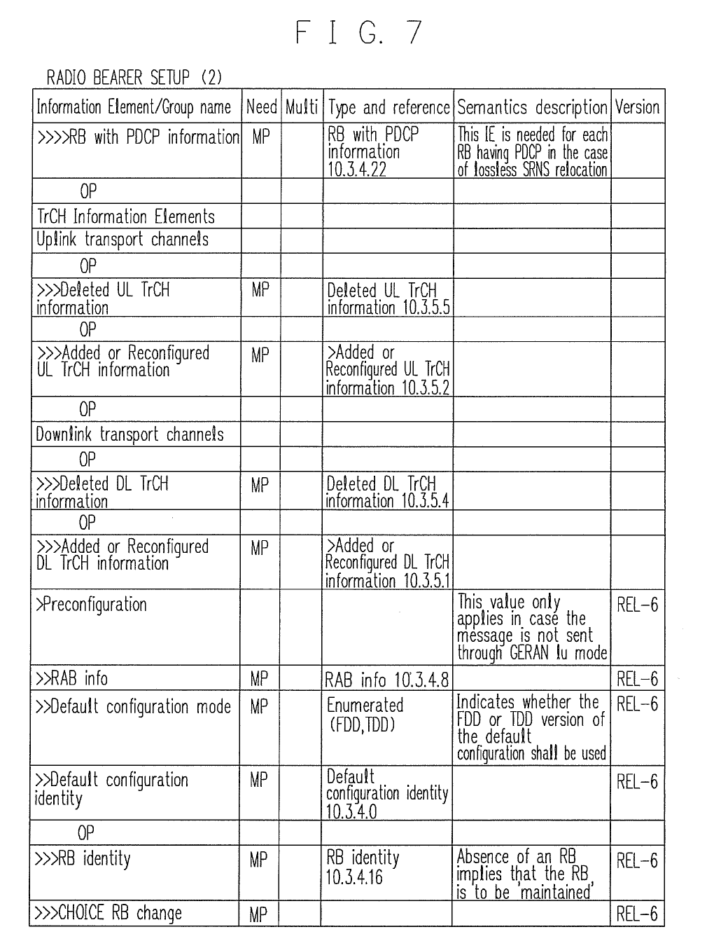

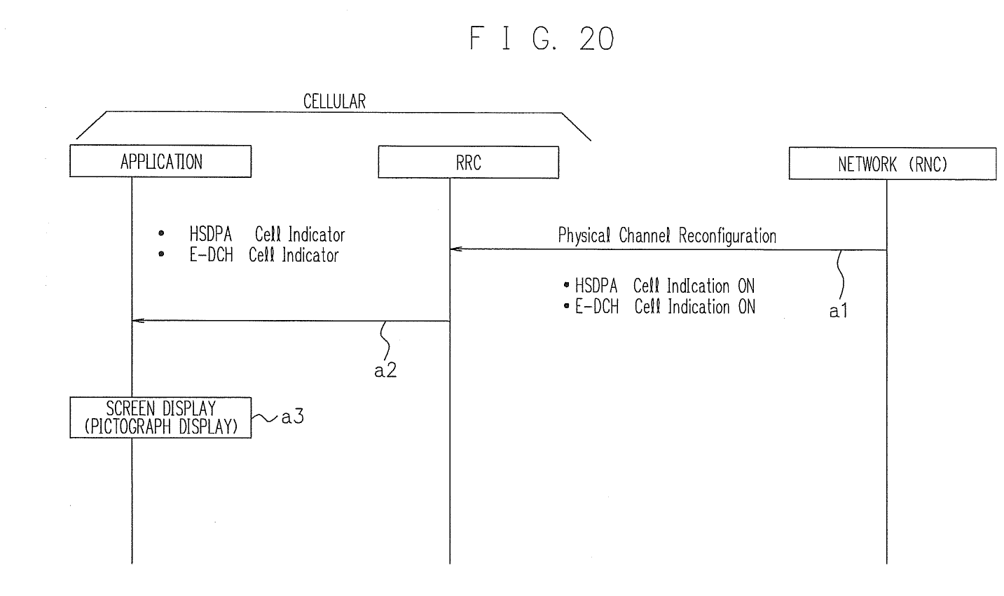

FIGS. 20 to 23 are sequence charts to explain a locating cell display method of a cellular system in accordance with the exemplary embodiment of the present invention. Referring to these FIGS. 1 to 10, description will be given of the locating cell display method of the cellular system in accordance with the exemplary embodiment of the present invention. Incidentally, processing of the cellular 1 and the radio network controller 3 shown in FIGS. 7 to 10 is implemented when the CPUs 11 and 31 respectively of the cellular 1 and the radio network controller 3 execute the control programs 12a and 32a.

In the mobile communication system, as an indicator to determine whether the user is currently locating in a cell supporting HSDPA or E-DCH, an HSDPA cell indicator and an E-DCH cell indicator are notified to the user by the notification information (“system information block type 5” or “system information block type 5bis”; reference is to be made to Non-Patent Document 1 described above).

The cellular 1 recognizes the indicator and displays on the screen of the display 14 an event in which the user is locating in a cell supporting HSDPA or E-DCH to thereby notify the situation to the user.

However, the cellular 1 cannot receive the notification information when it is using a dedicated channel (Detected Channel (DCH)); hence, when the cellular 1 moves to another cell while keeping the dedicated channel by, for example, a handover, the cellular 1 cannot determine whether the cell as a destination is a cell supporting HSDPA or E-DCH and hence cannot display appropriate pictograph on the screen of the display 14.

The exemplary embodiment conducts operation as follows to solve the above problem. First, description will be given of a situation wherein, for example, the cellular 1 moves to another cell while keeping the individual channel by a handover.

When a handover of the cellular 1 is notified from the cellular base station apparatus 2 as the handover source, the radio network controller 3 reads cellular base station information of a cellular base station apparatus 2 as a handover destination which the cellular base station information storage area 331 to determine whether the cellular base station apparatus 2 corresponds to HSDPA or E-DCH.

If it is determined that the cellular base station apparatus 2 as the destination corresponds to HSDPA and E-DCH, the radio network controller 3 notifies “HSDPA cell indicator on” and “E-DCH cell indicator on” to the cellular 1 by use of “physical channel reconfiguration” (a1 of FIG. 20).

In the cellular 1, at reception of “physical channel reconfiguration”, RRC extracts “HSDPA cell indicator” and “E-DCH cell indicator” to transmit the extracted result to the application (a2 of FIG. 20).

Since “HSDPA cell indicator on” and “E-DCH cell indicator on” are indicated, the application of the cellular 1 reads out pictograph data from the pictograph storage area 131 to display an event in which the cellular 1 is locating in a cell supporting HSDPA and an event in which the cellular 1 is locating in a cell supporting E-DCH and displays (pictograph) on the screen of the display 14 (a3 of FIG. 20).

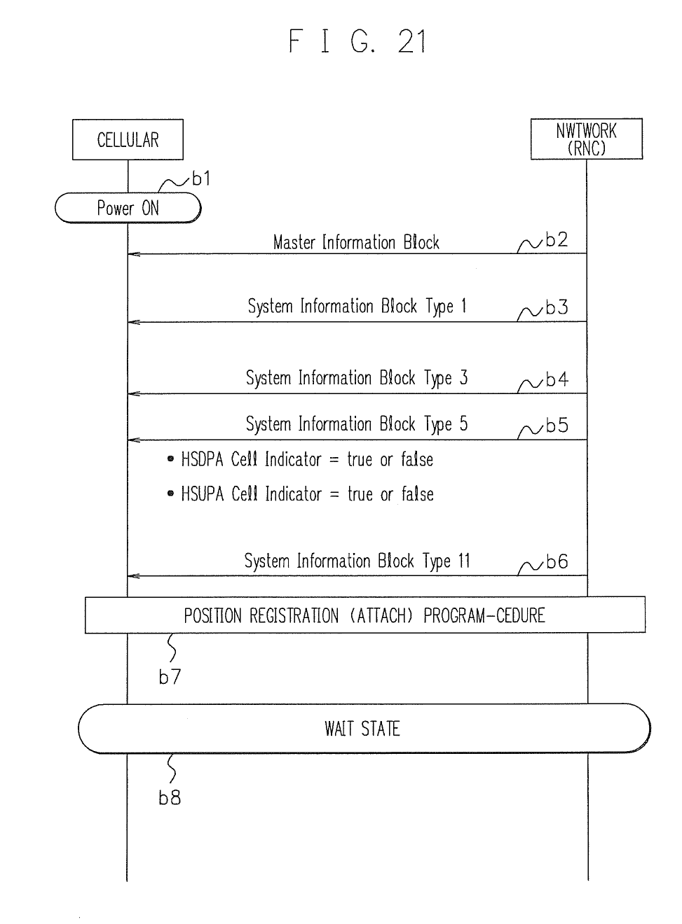

Next, referring to FIG. 21, description will be given of a case wherein “HSDPA cell indicator” and “E-DCH cell indicator” are notified by use of the notification information (“system information block type 5” or “system information block type 5bis”)

When the user turns on the switch of the cellular 1 (power on; b1 of FIG. 21), the cellular 1 receives, via the notification information, information necessary to set up communication such as shared channel setup information and information to measure peripheral cells; after the information is completely received (b2 to b6 of FIG. 21), the cellular 1 issues a request to the network for position registration [position registration (attach) program-cedure] (b7 of FIG. 21). Thereafter, the cellular 1 enters a waiting state (b8 of FIG. 21).

In this situation, the information necessary for communication setup includes “master information block” (b2 of FIG. 21), “system information block type 1” (b3 of FIG. 21), “system information block type 3” (b4 of FIG. 21), “system information block type 5 (·HSDPA cell indicator=true or false, ·HSUPA cell indicator=true or false” (b5 of FIG. 21), and “system information block type 11” (b6 of FIG. 21).

In an operation to receive such notification information, when “system information block type 5(bis)” is received and if “true” is set to “HSDPA cell indicator”, the cellular 1 conducts pictograph display of “the cellular is locating in a cell supporting HSDPA” on the screen of the display 14; if “true” is set to “E-DCH cell indicator”, the cellular 1 conducts pictograph display of “the cellular is locating in a cell supporting E-DCH (HSUPA)” on the screen of the display 14. Incidentally, “HSDPA cell indicator” and “E-DCH cell indicator” can be independently operated.

The notification information can be received not only when the cellular is turned on, but also at a required point, for example, in a waiting state and when the cellular moves to another cell while communicating via a shared channel. Since the notification information is information to be notified for each cell, if the notification information can be received, the cellular 1 (user) can determine whether the locating cell is a cell supporting HSDPA or HSUPA.

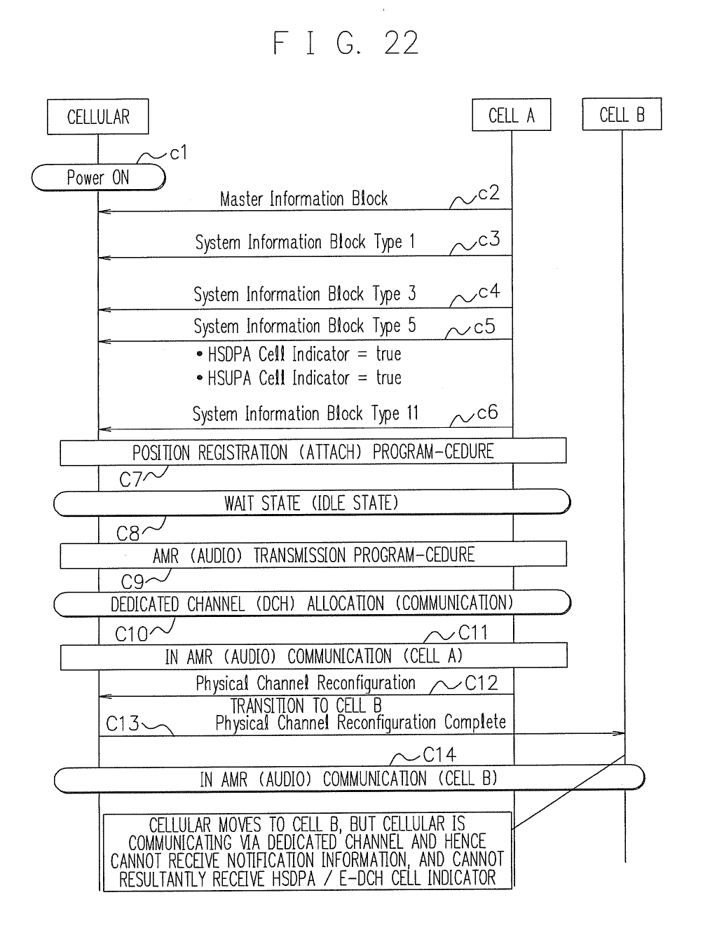

However, the notification information cannot be received during the communication via a dedicated channel; hence, when the cellular moves to another cell by a handover or the like while communicating via a dedicated channel, the notification information cannot be received in the cell of the destination; consequently, the cellular can receive neither “HSDPA cell indicator” nor “HSDPA cell indicator” of “system information block type 5(bis)” (reference is to be made to c1 to c13 of FIG. 22).

That is, when the user turns on the switch of the cellular 1 (power on; c1 of FIG. 22), the cellular 1 receives, via the notification information, information necessary to set up communication such as shared channel setup information and information to measure peripheral cells; after the information is completely received (c2 to c6 of FIG. 22), the cellular 1 issues a request to the network (radio network controller 3) for position registration [position registration (attach) program-cedure] (c7 of FIG. 22). Thereafter, the cellular 1 enters a waiting state (idle state; c8 of FIG. 22).

In this situation, the information necessary for communication setup includes “master information block” (c2 of FIG. 22), “system information block type 1” (c3 of FIG. 22), “system information block type 3” (c4 of FIG. 22), “system information block type 5 (·HSDPA cell indicator=true, ·HSUPA cell indicator=true” (c5 of FIG. 22), and “system information block type 11” (c6 of FIG. 22).

Thereafter, the cellular 1 conducts an Adaptive Multi Rate (AMR) (audio) transmission program-cedure (c9 of FIG. 22), dedicated channel (DCH:DCH) allocation (communication; c10 of FIG. 22), and “in AMR (audio) communication (cell A)” (c11 or FIG. 22) in cell A; when the cellular 1 receives “physical channel reconfiguration (c12 of FIG. 22) and conducts a transition to cell B, the cellular 1 returns “physical channel reconfiguration complete” (c13 of FIG. 22) and then conducts “in AMR (audio) communication (cell B)” (c14 or FIG. 22).

Although the cellular 1 conducts a transition to cell B, since it is communicating via a dedicated channel, the notification information cannot be received; resultantly, the HSDPA/E-DCH cell indicator cannot be received.

In the exemplary embodiment, to solve the above problem, it is assumed that each reconfiguration message is notified to the cellular 1 with “HSDPA cell indicator” and “E-DCH cell indicator” included therein (reference is to be made to FIG. 6). The reconfiguration message is a general term indicating messages to be notified from the network (radio network controller 3) to the cellular 1 to designate a handover in a situation wherein the transition of the state of the cellular 1 (RRC) is carried out or a parameter change is conducted for a radio channel, such as a physical channel, a transport channel, a logical channel.

At present, the reconfiguration messages prescribed by 3GPP include “radio bearer setup” (reference is to be made to FIGS. 6 to 8), “physical channel reconfiguration” (reference is to be made to FIG. 9), “transport channel reconfiguration (reference is to be made to FIGS. 10 and 11), “radio bearer reconfiguration” (reference is to be made to FIGS. 12 to 14), “cell update confirm” (reference is to be made to FIGS. 15 and 16), and “handover to Universal Terrestrial Radio Access Network (UTRAN) command” (reference is to be made to FIGS. 17 to 19).

To insert the information items of “HSDPA cell indicator” and “E-DCH cell indicator” in each reconfiguration message described above, a message extension is required. However, in the description of Abstract Syntax Notation. 1 (ASN.1), by adding the information items in the form of extension, the message extension can be carried out while keeping backward compatibility.

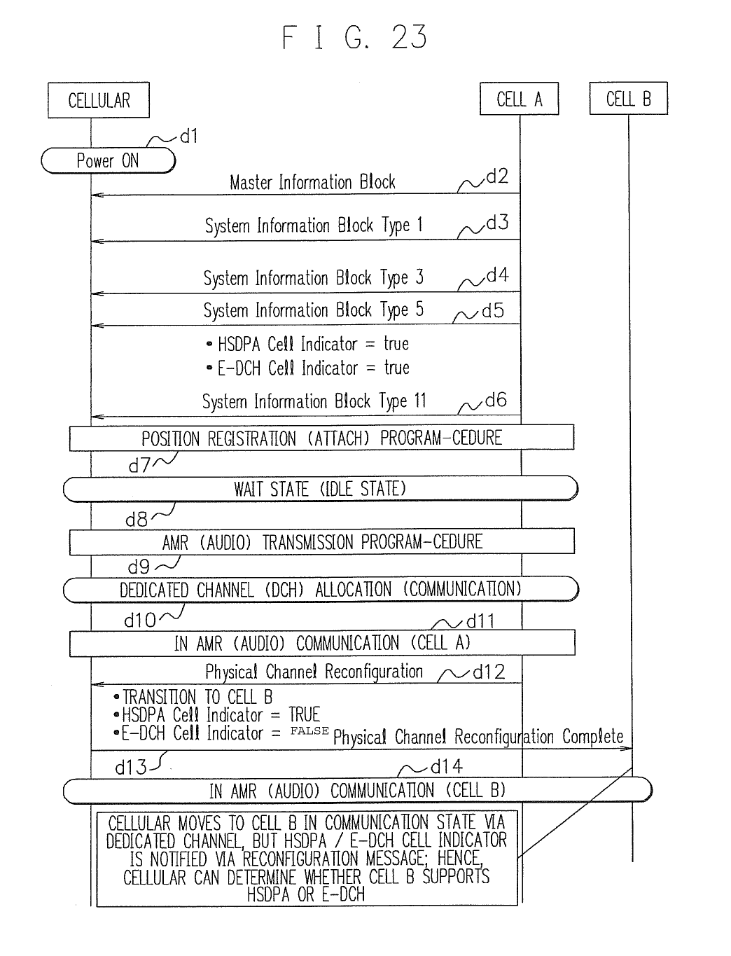

FIG. 23 shows a sequence when the message extension of “HSDPA cell indicator” and “E-DCH cell indicator” is additionally carried out as described above. In FIG. 23, when the cellular 1 in communication via a dedicated channel is moved from cell A to cell B, it is possible in the exemplary embodiment to recognize “HSDPA cell indicator” and “E-DCH cell indicator” in cell B according to “physical channel reconfiguration message (d12 and d13 of FIG. 23); resultantly, it is possible to display, on the screen of the display 14 of the cellular 1, pictograph indicating whether or not the locating cell is a cell supporting HSDPA or E-DCH (HSUPA).

That is, when the user turns on the switch of the cellular 1 (power on; d1 of FIG. 22), the cellular 1 receives, via the notification information, information necessary to set up communication such as shared channel setup information and information to measure peripheral cells; after the information is completely received (d2 to d6 of FIG. 23), the cellular 1 issues a request to the network (radio network controller 3) for position registration [position registration (attach) program-cedure] (d7 of FIG. 23). Thereafter, the cellular 1 enters a waiting state (idle state; d8 of FIG. 23).

In this situation, the information necessary for communication setup includes “master information block” (d2 of FIG. 23), “system information block type 1” (d3 of FIG. 23), “system information block type 3” (d4 of FIG. 23), “system information block type 5 (·HSDPA cell indicator=true, ·E-DCH cell indicator=true” (d5 of FIG. 23), and “system information block type 11” (d6 of FIG. 23).

Thereafter, the cellular 1 conducts an AMR (audio) transmission program-cedure (d9 of FIG. 23), dedicated channel (DCH) allocation (communication; d10 of FIG. 23), and “in AMR (audio) communication (cell A)” (d11 or FIG. 23) in cell A; thereafter, when the cellular 1 receives “physical channel reconfiguration (·transition to cell B, ·HSDPA cell indicator=true, ·E-DCH cell indicator=false)” (d12 of FIG. 23), the cellular 1 returns “physical channel reconfiguration complete” (d13 of FIG. 23) and then conducts “in AMR (audio) communication (cell B)” (d14 or FIG. 23).

Although the cellular 1 conducts a transition to cell B in the state of communication via a dedicated channel, “HSDPA/E-DCH cell indicator” is notified via the reconfiguration message; hence it is possible to determine whether or not cell B is a cell supporting HSDPA or E-DCH.

The exemplary embodiment utilizes the HSDPA and E-DCH (HSUPA) cell indicators; however, the cell indicators may be used not only for HSDPA and E-DCH (HSUPA) services, but also for an operation to notify service corresponding information of each cell from the network to the cellular 1 (user).

This application is based upon and claims the benefit of priority from Japanese patent application No. 2006-222966, filed on Aug. 23, 2006, the disclosure of which is incorporated herein in its entirety by reference.

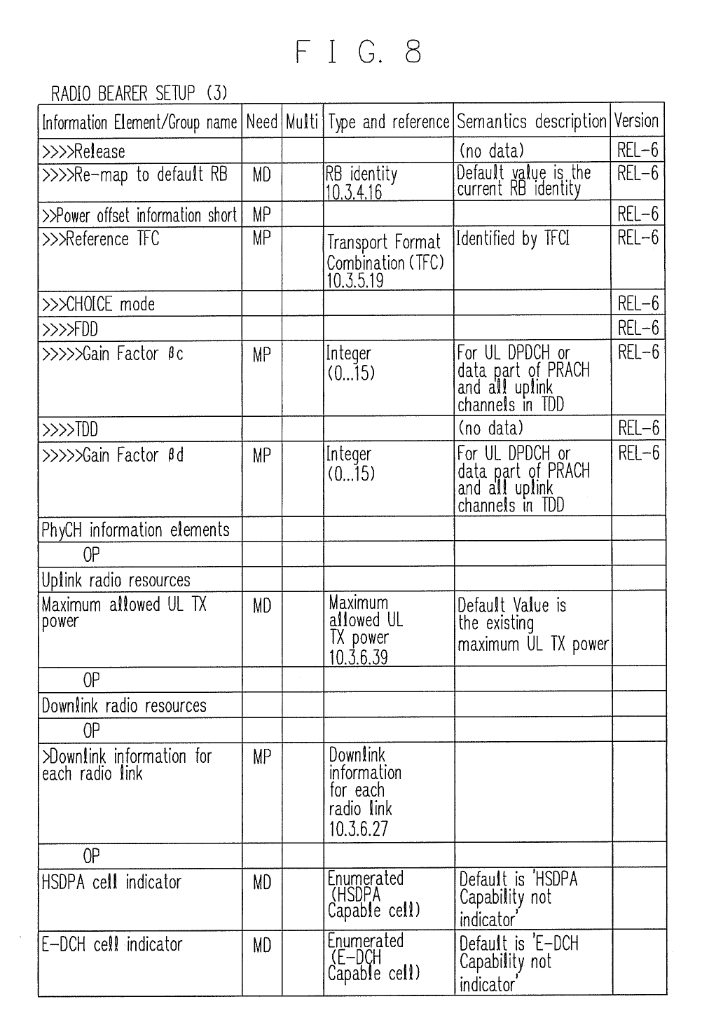

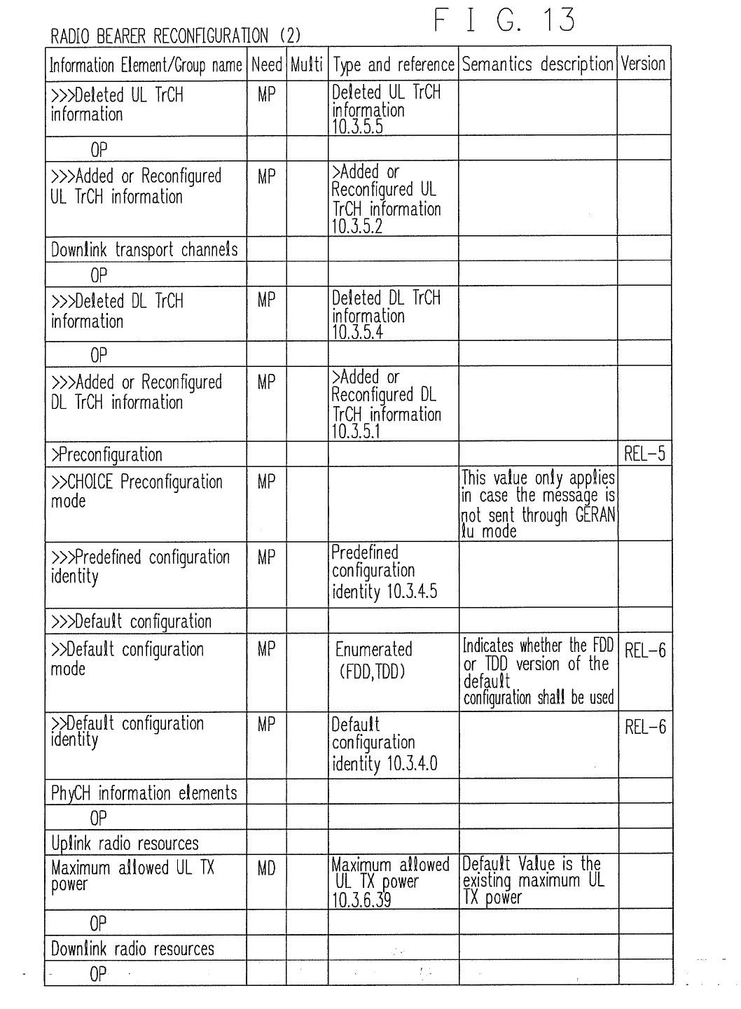

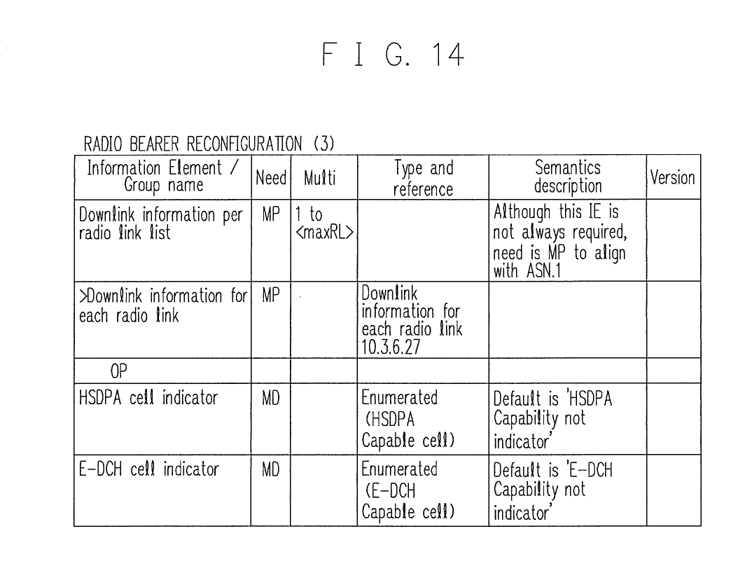

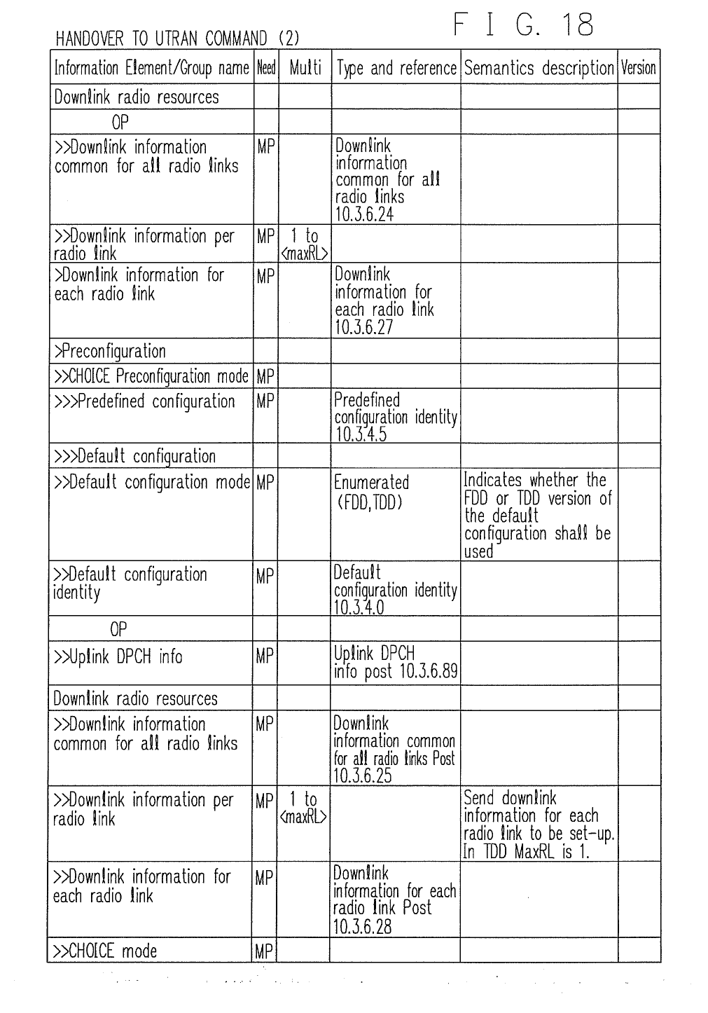

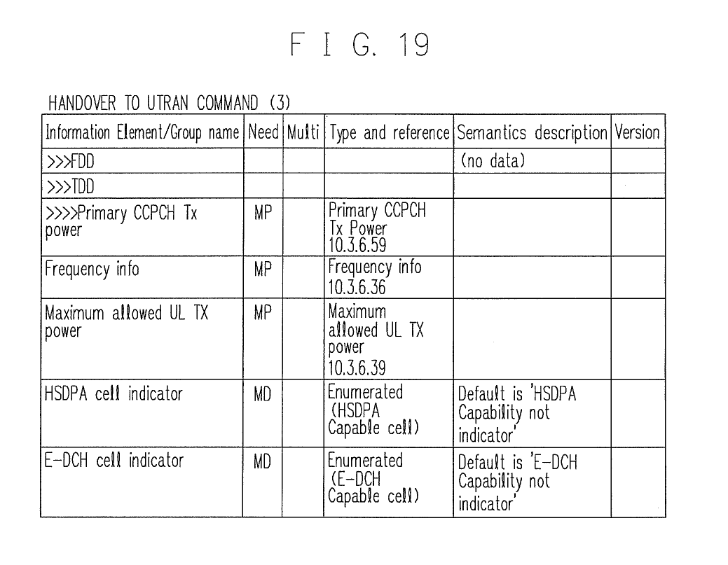

### BRIEF DESCRIPTION OF DRAWINGS

[FIG. 1] is a block diagram showing a configuration example of a mobile communication system according to an exemplary embodiment of the present invention.

[FIG. 2] is a diagram showing a protocol architecture of a radio interface employed in the exemplary embodiment of the present invention.

[FIG. 3] is a block diagram showing a configuration example of a cellular of FIG. 1.

[FIG. 4] is a block diagram showing a configuration example of a radio network controller of FIG. 1.

[FIG. 5] is a diagram showing pictograph display example of “locating in cell supporting HSDPA” and “locating in cell supporting E-DCH” for the cellular of FIG. 1.

[FIG. 6] is a diagram showing a format example of a reconfiguration message according to the exemplary embodiment of the present invention.

[FIG. 7] is a diagram showing a format example of the reconfiguration message according to the exemplary embodiment of the present invention.

[FIG. 8] is a diagram showing a format example of the reconfiguration message according to the exemplary embodiment of the present invention.

[FIG. 9] is a diagram showing a format example of the reconfiguration message according to the exemplary embodiment of the present invention.

[FIG. 10] is a diagram showing a format example of the reconfiguration message according to the exemplary embodiment of the present invention.

[FIG. 11] is a diagram showing a format example of the reconfiguration message according to the exemplary embodiment of the present invention.

[FIG. 12] is a diagram showing a format example of the reconfiguration message according to the exemplary embodiment of the present invention.

[FIG. 13] is a diagram showing a format example of the reconfiguration message according to the exemplary embodiment of the present invention.

[FIG. 14] is a diagram showing a format example of the reconfiguration message according to the exemplary embodiment of the present invention.

[FIG. 15] is a diagram showing a format example of the reconfiguration message according to the exemplary embodiment of the present invention.

[FIG. 16] is a diagram showing a format example of the reconfiguration message according to the exemplary embodiment of the present invention.

[FIG. 17] is a diagram showing a format example of the reconfiguration message according to the exemplary embodiment of the present invention.

[FIG. 18] is a diagram showing a format example of the reconfiguration message according to the exemplary embodiment of the present invention.

[FIG. 19] is a diagram showing a format example of the reconfiguration message according to the exemplary embodiment of the present invention.

[FIG. 20] is a sequence chart to explain a locating cell display method in a cellular system according to the exemplary embodiment of the present invention.

[FIG. 21] is a sequence chart to explain the locating cell display method in the cellular system according to the exemplary embodiment of the present invention.

[FIG. 22] is a sequence chart to explain the locating cell display method in the cellular system according to the exemplary embodiment of the present invention.

[FIG. 23] is a sequence chart to explain the locating cell display method in the cellular system according to the exemplary embodiment of the present invention.

### DESCRIPTION OF REFERENCE NUMERALS

1 Cellular
2 Cellular base station apparatus
3 Radio network controller
4 Core network
11, 31 CPU
12, 32 Main memory
12a, 32a Control program
13, 33 Storage
14 Display
15 Radio communication module
16 Antenna
34 Communication controller
100 Cellular system
110, 310 Internal bus

1. A mobile communication system in which a base station apparatus notifies, by use of notification information from the base station apparatus to a cellular, service corresponding information of a cell under control of the base station apparatus to the cellular, wherein
at a transition of a state of the cellular, the service corresponding information of the cell is added to a message to be notified from the base station apparatus and is notified to the cellular.

2. The mobile communication system in accordance with claim 1, wherein the cellular comprises a determining unit which determines the service corresponding information of the cell in the message and a displaying unit which displays on a screen the service correspondence of the cell obtained by determining the service corresponding information.

3. The mobile communication system in accordance with claim 2, wherein the displaying unit for displaying the service correspondence of the cell on the screen displays pictograph of the service correspondence of the cell by use of at least pictorial symbols on the screen.

4. The mobile communication system in accordance with claim 1, wherein at least when the transition of the state of the cellular is carried out, when a parameter change is conducted for a radio channel including at least a physical channel, a transport channel, and a logical channel, and when a handover is designated, the message is a reconfiguration message notified from the base station apparatus to the cellular.

5. The mobile communication system in accordance with claim 4, wherein the message is applicable to a message which is notified from the radio network controller controlling the base station apparatus to the cellular via the base station apparatus.

6. The mobile communication system in accordance with claim 1, wherein the service corresponding information of the cell includes indicators which indicate whether at least the cellular is locating in cells supporting High Speed Downlink Packet Access (HSDPA) and Enhanced-Detected Channel (E-DCH).

7. The mobile communication system in accordance with claim 1, wherein the notification information is either one of “system information block type 5” and “system information block type 5bis”.

8. A radio network controller for controlling a base station apparatus in a system in which the base station apparatus notifies, by use of notification information from the base station apparatus to a cellular, service corresponding information of a cell under control of the base station apparatus to the cellular, comprising:
a determining unit which determines, at a transition of a state of the cellular, a correspondence between a base station apparatus associated with the transition and the service of the cell; and
an adding unit which adds, when it is determined that the base station apparatus corresponds to the service of the cell, the service corresponding information of the cell of the base station apparatus to a message to be notified from the base station apparatus to the cellular to thereby notify the information to the cellular.

9. The radio network controller in accordance with claim 8, wherein at least when the transition of the state of the cellular is carried out, when a parameter change is conducted for a radio channel including at least a physical channel, a transport channel, and a logical channel, and when a handover is designated, the message is a reconfiguration message notified from the base station apparatus to the cellular.

10. The radio network controller in accordance with claim 8, wherein the service corresponding information of the cell includes indicators which indicate whether at least the cellular is locating in cells supporting High Speed Downlink Packet Access (HSDPA) and

11. The radio network controller in accordance with claim 8, wherein the notification information is either one of “system information block type 5” and “system information block type 5bis”

12. A cellular to which, by use of notification information from a base station apparatus to a cellular, service corresponding information of a cell under control of the base station apparatus is notified, comprising:
a determining unit which determines a service correspondence of the cell according to the service corresponding information added to a message notified from the base station apparatus at a transition of a state of the cellular; and
a displaying unit which displays on a screen the service correspondence of the cell obtained by determining the service correspondence.

13. The cellular in accordance with claim 12, wherein the displaying unit for displaying the service correspondence of the cell on the screen displays pictograph of the service correspondence of the cell by use of at least pictorial symbols on the screen.

14. The cellular in accordance with claim 12, wherein at least when the transition of the state of the cellular is carries out, when a parameter change is conducted for a radio channel including at least a physical channel, a transport channel, and a logical channel, and when a handover is designated, the message is a reconfiguration message notified from the base station apparatus.

15. The cellular in accordance with claim 14, wherein the message is applicable to a message which is notified from the radio network controller controlling the base station apparatus via the base station apparatus.

16. The cellular in accordance with claim 12, wherein the service corresponding information of the cell includes indicators which indicate whether at least the cellular is locating in cells supporting High Speed Downlink Packet Access (HSDPA) and Enhanced-Detected Channel (E-DCH).

17. The cellular in accordance with claim 12, wherein the notification information is either one of “system information block type 5” and “system information block type 5bis”.

18. A locating cell display method for use with a mobile communication system in which a base station apparatus notifies, by use of notification information from the base station apparatus to a cellular, service corresponding information of a cell under control of the base station apparatus to the cellular, wherein
at a transition of a state of the cellular, the service corresponding information of the cell is added to a message to be notified from the base station apparatus and is notified to the cellular.

19. The locating cell display method in accordance with claim 18, wherein the cellular executes processing for determining the service corresponding information of the cell in the message and processing for displaying on a screen the service correspondence of the cell obtained by determining the service corresponding information.

20. The locating cell display method in accordance with claim 19, wherein in the processing for displaying the service correspondence of the cell on the screen displays, the service correspondence of the cell is displayed as pictograph by use of at least pictorial symbols on the screen.

21. The locating cell display method in accordance with claim 18, wherein at least when the transition of the state of the cellular is carried out, when a parameter change is conducted for a radio channel including at least a physical channel, a transport channel, and a logical channel, and when a handover is designated, the message is a reconfiguration message notified from the base station apparatus to the cellular.

22. The locating cell display method in accordance with claim 21, wherein the message is applicable to a message which is notified from the radio network controller controlling the base station apparatus to the cellular via the base station apparatus.

23. The locating cell display method in accordance with claim 18, wherein the service corresponding information of the cell includes indicators which indicate whether at least the cellular is locating in cells supporting High Speed Downlink Packet Access (HSDPA) and Enhanced-Detected Channel (E-DCH).

24. The locating cell display method in accordance with claim 18, wherein the notification information is either one of “system information block type 5” and “system information block type 5bis”.

25. A radio network controller for controlling a base station apparatus in a system in which the base station apparatus notifies, by use of notification information from the base station apparatus to a cellular, service corresponding information of a cell under control of the base station apparatus to the cellular, comprising:
means for determining, at a transition of a state of the cellular, a correspondence between a base station apparatus associated with the transition and the service of the cell; and
means for adding, when it is determined that the base station apparatus corresponds to the service of the cell, the service corresponding information of the cell of the base station apparatus to a message to be notified from the base station apparatus to the cellular to thereby notify the information to the cellular.

26. A cellular to which, by use of notification information from a base station apparatus to a cellular, service corresponding information of a cell under control of the base station apparatus is notified, comprising:
means for determining a service correspondence of the cell according to the service corresponding information added to a message notified from the base station apparatus at a transition of a state of the cellular; and
means for displaying on a screen the service correspondence of the cell obtained by determining the service correspondence.
